(19) United States
(12) Patent Application Publication
(10) Pub. No.: US 2025/0285471 A1
(43) Pub. Date: Sep. 11, 2025

(54) METHOD AND SYSTEM FOR PREVENTING IDENTITY SPOOFING USING ARTIFICIAL INTELLIGENCE DRIVEN PATTERN RECOGNITION

(71) Applicants: Nithya Rekha SIVAKUMAR, Riyadh (SA); Thangavel MURUGAN, Al Ain (AE); Abdur Rahman SARKER, Dhaka (BD); Raja Varma PAMBA, Dubai (AE); Mohammed Mafizul ISLAM, Dhaka (BD); Zikra AMIN, Dhaka (BD); Sarika SASEENDRAN, Kalady (IN); Md. MONERUZZAMAN, Dhaka (BD); S.M.G. AZAM, Bagha (BD); Syed Mohammed TAREQ, Mississippi, MS (US); Md Kamrus SAMAD, Dhaka (BD); Mohit TIWARI, Delhi (IN); Md. Omar Faruque REZA, Dhaka (BD); Syed Md Shamsul ALAM, Flagstaff, AZ (US); Balajee JEYAKUMAR, Palamaner (IN)

(72) Inventors: Nithya Rekha SIVAKUMAR, Riyadh (SA); Thangavel MURUGAN, Al Ain (AE); Abdur Rahman SARKER, Dhaka (BD); Raja Varma PAMBA, Dubai (AE); Mohammed Mafizul ISLAM, Dhaka (BD); Zikra AMIN, Dhaka (BD); Sarika SASEENDRAN, Kalady (IN); Md. MONERUZZAMAN, Dhaka (BD); S.M.G. AZAM, Bagha (BD); Syed Mohammed TAREQ, Mississippi, MS (US); Md Kamrus SAMAD, Dhaka (BD); Mohit TIWARI, Delhi (IN); Md. Omar Faruque REZA, Dhaka (BD); Syed Md Shamsul ALAM, Flagstaff, AZ (US); Balajee JEYAKUMAR, Palamaner (IN)

(21) Appl. No.: 19/212,505

(22) Filed: May 19, 2025

(51) Int. Cl. G06V 40/40; G06V 10/82; G06V 40/70

(52) U.S. Cl. CPC G06V 40/40; G06V 10/82; G06V 40/70

(57) ABSTRACT

The invention provides a method and system for preventing identity spoofing during digital authentication processes using artificial intelligence (AI)-driven pattern recognition. The system receives an input data stream from a user attempting to authenticate, which may include biometric data, device behavior data, or user interaction data. An AI-based pattern recognition model processes this data to analyze user behavior patterns and detect any anomalies that may indicate potential spoofing attempts. The system compares the processed data against a pre-established user profile to generate an authentication decision. If anomalies are detected, the system can flag the authentication for further review or trigger additional verification steps, such as multi-factor authentication (MFA) or one-time password (OTP) prompts. The system continuously learns from user interaction data and dynamically updates the user profile to improve the accuracy of identity verification.

### FIELD OF THE INVENTION

The present invention relates to the field of cybersecurity and identity verification systems. More specifically, it pertains to a method and system for preventing identity spoofing using artificial intelligence (AI)-driven pattern recognition techniques integrated within a hardware-based identity authentication module.

### BACKGROUND OF THE INVENTION

Identity spoofing has emerged as a critical threat in various domains including online banking, e-commerce, government services, and enterprise access control. Conventional systems often rely on static identity verification methods such as passwords, personal identification numbers (PINs), or basic biometric inputs like facial or fingerprint recognition. These systems are highly vulnerable to spoofing attacks wherein malicious actors mimic or replicate legitimate users' credentials or biometric features using synthetic data, deepfakes, or stolen identities. While multi-factor authentication (MFA) and encryption have enhanced security, attackers continue to evolve tactics that bypass these measures, highlighting a need for dynamic, real-time, intelligent defense mechanisms.

Existing solutions lack the capability to continuously assess behavioral, biometric, and contextual patterns for anomaly detection in identity claims. Furthermore, many software-based approaches are susceptible to tampering and lack physical integrity. Therefore, there exists a need for a robust system and method that can dynamically recognize identity spoofing attempts through advanced AI-driven pattern recognition techniques embedded within a secure and tamper-resistant physical device.

Identity spoofing remains one of the most pervasive threats in the domain of digital security and user authentication systems. It encompasses a broad range of malicious activities where an adversary attempts to gain unauthorized access to systems or services by impersonating a legitimate user. Spoofing attacks can target biometric authentication systems (such as facial recognition or fingerprint scans), behavioral profiling systems (such as keystroke or gait analysis), or even device-based authentication methods (such as MAC address or IP spoofing). With the exponential growth of digital services—including online banking, e-governance platforms, e-commerce portals, and enterprise remote access—there has been a corresponding rise in the sophistication of identity spoofing techniques. Attackers today employ synthetic identities, AI-generated deepfake content, voice cloning, and advanced spoof kits to bypass even relatively advanced identity verification solutions. The vulnerabilities of existing systems, coupled with the rapidly evolving threat landscape, highlight the inadequacy of current methods in reliably and consistently protecting user identity.

Traditional identity verification systems often rely heavily on static knowledge-based factors such as passwords, security questions, or token-based authentication. While these methods were foundational in early digital security paradigms, they have proven increasingly susceptible to social engineering, phishing, credential stuffing, and brute force attacks. Once compromised, such credentials are difficult to revoke or replace promptly, especially when associated with legacy systems. Moreover, such systems do not dynamically assess the context or behavior of the user, rendering them inadequate in high-risk or adaptive threat environments.

The advent of biometric authentication was seen as a significant improvement over passwords. Fingerprint recognition, iris scanning, facial recognition, and voice biometrics introduced a layer of identity tied to the physical or physiological traits of a user. These systems promised non-repudiation and convenience. However, they too suffer from limitations, especially in the context of spoofing. Fingerprint sensors can be deceived using high-resolution images, silicone casts, or latent print lifts. Facial recognition systems are notoriously vulnerable to high-quality photographs, video replays, and most recently, deepfake-generated synthetic faces that exhibit convincing 3D geometry and texture dynamics. Voice authentication systems, once considered highly secure due to their reliance on vocal pitch, tone, and cadence, are increasingly defeated using AI-powered voice synthesis technologies that clone a user's voice from mere seconds of training audio. These developments have rendered many commercial biometric systems insufficient for critical security applications, particularly in unattended or remote verification settings.

Another approach used in contemporary systems is multi-factor authentication (MFA), which requires users to present a combination of knowledge (e.g., password), possession (e.g., mobile device or OTP), and inherence (e.g., biometric data). While MFA undoubtedly strengthens the authentication process, its effectiveness depends significantly on implementation. Many MFA systems still rely on SMS-based OTPs, which are susceptible to SIM-swapping attacks, interception via malware, or social engineering of telecom providers. Mobile push notifications, although more secure, can still be bypassed by overlay attacks or malicious applications granting remote control access to the device. Furthermore, MFA does not inherently analyze the user's behavior or environment for anomalies, making it less adaptive against novel attack vectors.

Behavioral biometrics emerged as a promising countermeasure, analyzing user interactions such as keystroke dynamics, mouse movements, touchscreen pressure, gait, and device usage patterns to develop a unique behavioral profile for each user. When integrated with AI or machine learning, these systems can identify deviations from a user's typical behavior, flagging potential anomalies in real time. However, behavioral biometric systems face significant challenges in terms of data quality, environmental variability, and false positives. For instance, users may exhibit different behavioral patterns when fatigued, injured, or using unfamiliar devices, potentially leading to incorrect rejection. Additionally, attackers have started to mimic behavioral traits by studying video footage or capturing input streams from compromised sessions, reducing the reliability of such models in isolation.

Context-aware authentication, which factors in geolocation, device fingerprinting, time-of-day access, and IP reputation, is another defense layer used in identity systems. These methods add an additional filter by correlating access attempts with expected patterns or known safe environments. Yet, these systems also have their limitations. For example, device fingerprinting can be circumvented using virtual machines, VPNs, and spoofed user-agent strings. Geolocation data is not foolproof and can be manipulated using GPS spoofing apps or IP proxies. Furthermore, these methods tend to be more effective in enterprise-controlled environments but perform poorly in open systems where users frequently change networks, devices, or access locations.

Liveness detection was introduced as a countermeasure in biometric systems to ensure that a real human, rather than a synthetic or replayed source, is presenting the biometric input. These mechanisms often use eye blink detection, thermal sensing, motion-based depth estimation, or challenge-response tasks to distinguish between live users and spoof attempts. However, liveness detection has been rapidly outpaced by innovations in synthetic media and AI-generated content. Deepfakes, for example, can replicate blinking, facial micro-expressions, and real-time depth cues convincingly enough to deceive liveness detection systems, especially those that use conventional rule-based approaches. Moreover, such systems can increase user friction, particularly when challenges are intrusive or not universally accessible (e.g., asking a visually impaired person to complete a visual CAPTCHA).

In light of these challenges, AI has been integrated into many identity verification pipelines to perform spoof detection using data-driven learning. Convolutional neural networks (CNNs) are employed to analyze facial textures for signs of image manipulation, while recurrent neural networks (RNNs) are used to detect temporal anomalies in behavior. Generative adversarial networks (GANs) are also leveraged to improve the training of spoof detectors by generating adversarial examples. While these AI techniques have advanced the state of the art, they are often deployed as cloud-based services, creating latency and privacy concerns. Furthermore, the models used are only as good as the data they are trained on. Bias in datasets, lack of representative spoofing techniques, and inadequate model generalization can all lead to failure when the system encounters a new or previously unseen form of identity spoofing.

Existing systems also lack secure physical integration. Most AI-based authentication systems operate in software environments that are vulnerable to tampering, reverse engineering, or network-based attacks. The absence of secure hardware modules means that even the best pattern recognition techniques can be bypassed if the input data stream is compromised or simulated upstream. For instance, if an attacker can inject falsified biometric data or sensor readings before they reach the software model, the detection mechanism can be rendered useless.

Additionally, many systems struggle with scalability and adaptability. In high-volume or real-time environments such as border control, enterprise authentication servers, or financial fraud detection systems, latency and throughput become critical. AI models require high processing power, and cloud-based inference can introduce unacceptable delays or become unavailable during network outages. Offline AI models, if not updated regularly, can become obsolete and ineffective against new attack types.

The need for a unified, AI-driven identity verification system that incorporates secure hardware, real-time adaptive pattern recognition, and continuous learning is more urgent than ever. Such a system must address the multi-dimensional nature of identity, integrate both biometric and behavioral cues, and evolve in response to new threats without compromising user privacy or convenience. This technical background underscores the imperative for the invention of a method and system that goes beyond static checks and embraces dynamic, AI-driven decision-making for robust identity spoofing prevention.

### SUMMARY OF THE INVENTION

The present invention provides a method and system for preventing identity spoofing by employing AI-driven pattern recognition techniques implemented within a secure hardware module. The system continuously monitors and analyzes multi-modal identity input data—such as facial expressions, voice modulations, typing rhythms, device usage behaviors, and environmental parameters—to establish real-time user authenticity.

The invention comprises a secure identity authentication device, hereafter referred to as the “AI Pattern Recognition Identity Module” (AIPRIM), which integrates a multi-core neural processor, a biometric sensor array, and a tamper-resistant hardware enclosure. AIPRIM executes a trained deep learning model capable of real-time decision-making based on complex data patterns associated with genuine and spoofed identity inputs. The system applies advanced pattern recognition, including convolutional neural networks (CNNs) for image-based biometrics, recurrent neural networks (RNNs) for behavioral sequences, and adversarial spoof detection to proactively identify potential spoofing attempts.

The method involves the following core steps: (i) collecting live multi-modal biometric and behavioral data, (ii) preprocessing and vectorization of data using in-device encoders, (iii) feeding data into a fusion AI model for authentication scoring, and (iv) generating a trust signal or rejection alert based on confidence thresholds. The trust signal is cryptographically signed and sent to an external host system to grant or deny access. The system also supports federated learning to update its pattern recognition model without exposing sensitive identity data externally, ensuring data privacy and continual model improvement.

The primary object of the present invention is to provide a method and system capable of preventing identity spoofing in digital authentication processes through the application of advanced AI-driven pattern recognition techniques. This invention seeks to overcome the limitations of existing identity verification systems by integrating multiple data sources, including biometric features, behavioral patterns, and contextual information, to enhance the accuracy and reliability of user authentication. Another object of the invention is to develop a robust system that utilizes machine learning techniques to continuously adapt to evolving spoofing techniques, thereby improving its ability to detect new and previously unseen spoofing attempts. Furthermore, the invention aims to improve the overall security of identity verification systems by incorporating secure hardware components that ensure the integrity and authenticity of data during the acquisition, processing, and transmission phases. This invention also seeks to minimize latency and reduce the computational burden on centralized servers by enabling real-time, on-device AI processing, ensuring seamless operation even in bandwidth-limited or offline environments. Another object is to create a scalable and customizable solution that can be easily integrated with a variety of digital platforms and services, such as financial institutions, government systems, and enterprise applications, to provide comprehensive protection against identity spoofing across diverse use cases. Additionally, the invention aims to provide a solution that is adaptable to a wide range of users, contexts, and devices, ensuring both high accuracy and user convenience, while addressing the challenges posed by spoofing methods such as deepfakes, synthetic biometrics, and AI-driven attacks. Ultimately, the invention strives to establish a more secure, reliable, and user-friendly approach to identity verification, setting a new standard in combating digital identity fraud.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for Preventing Identity Spoofing Using AI-Driven Pattern Recognition; and

FIG. 2 displays flow chart of a method for Preventing Identity Spoofing Using AI-Driven Pattern Recognition.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

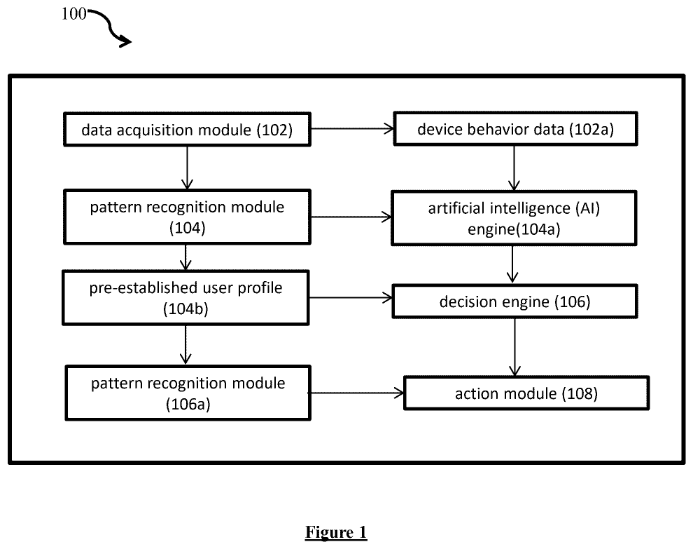

Referring to FIG. 1, a block diagram of a system for Preventing Identity Spoofing Using AI-Driven Pattern Recognition is illustrated. The system 100 comprising: a data acquisition module (102) configured to receive an input data stream from a user, the input data stream including biometric data, device behavior data (102a), or user interaction data; a pattern recognition module (104) comprising an artificial intelligence (AI) engine (104a) configured to process and analyze the input data stream by comparing it with a pre-established user profile (104b), wherein the AI engine utilizes one or more pattern recognition techniques to detect anomalies that indicate identity spoofing; a decision engine (106) configured to generate an authentication decision based on the output of the pattern recognition module (106a); an action module (108) in communication with the decision engine, wherein the action module performs one or more actions based on the authentication decision, the actions including granting or denying access or flagging the authentication for additional review.

In an embodiment, the AI engine (104a) uses a machine learning-based classification technique selected from the group consisting of support vector machines (SVM), random forests, and neural networks to analyze the input data stream.

In an embodiment, the pre-established user profile (104b) includes a repository of historical biometric data, user device usage statistics, and interaction patterns, which are continuously updated to enhance the accuracy of identity verification.

In an embodiment, the pattern recognition module (106a) further includes a feature extraction component that extracts behavioral features from the input data stream, and a comparison component that compares the extracted features with the established user profile.

In an embodiment, the action module (108) further triggers a security protocol when the authentication decision is flagged for additional review, wherein the security protocol includes at least one of alerting a security administrator, initiating an additional identity verification step, or initiating a session termination protocol.

In an embodiment, the data acquisition module (102) includes biometric sensors configured to capture at least one of facial images, fingerprints, voice recordings, or eye patterns for use in the authentication process.

In an embodiment, the device behavior data (102a) includes at least one of device usage patterns, typing behavior, application access patterns, and geographical location, and wherein the pattern recognition module analyzes this data to detect potential identity spoofing attempts.

In an embodiment, the AI engine (104a) continuously learns from new user interaction data and dynamically updates the pre-established user profile to improve the detection of spoofing patterns.

In an embodiment, the system further comprises a feedback module that provides real-time feedback to the user based on the outcome of the authentication decision, wherein the feedback includes a prompt for additional authentication if the decision is flagged for review.

In an embodiment, a non-transitory computer-readable medium storing instructions that, when executed by a processor, perform the method of claim 1.

In an embodiment, the instructions further cause the processor to implement an adaptive learning mechanism that refines the authentication decision-making process over time based on user behavior data and identified spoofing patterns.

In an embodiment, the action module further triggers a security protocol when the authentication decision is flagged for additional review, wherein the security protocol includes at least one of alerting a security administrator, initiating an additional identity verification step, or initiating a session termination protocol, wherein the data acquisition module includes biometric sensors configured to capture at least one of facial images, fingerprints, voice recordings, or eye patterns for use in the authentication process, wherein the device behavior data includes at least one of device usage patterns, typing behavior, application access patterns, and geographical location, and wherein the pattern recognition module analyzes this data to detect potential identity spoofing attempts, wherein the AI engine continuously learns from new user interaction data and dynamically updates the pre-established user profile to improve the detection of spoofing patterns, and wherein the system further comprises a feedback module that provides real-time feedback to the user based on the outcome of the authentication decision, wherein the feedback includes a prompt for additional authentication if the decision is flagged for review.

In this embodiment, the action module plays a critical role in enhancing system security by activating a security protocol whenever an authentication decision is flagged for additional scrutiny. This security protocol is designed to address potential threats through multiple reactive measures, such as alerting a designated security administrator to intervene, initiating further identity verification steps to confirm user legitimacy, or terminating the user's session to prevent unauthorized access. The data acquisition module is equipped with an array of biometric sensors capable of capturing diverse biometric data types, including facial images through cameras, fingerprints via touch sensors, voice recordings using microphones, and eye patterns via iris or retina scanners. These biometric inputs complement the device behavior data collected, which encompasses various user activity metrics such as device usage patterns, typing rhythms, application access sequences, and geographical location tracking. The pattern recognition module processes and analyzes this combined biometric and behavioral data to identify suspicious or anomalous activity indicative of potential identity spoofing attempts, such as forged biometric inputs or unusual usage behavior that deviates from the user's typical profile.

The system's AI engine is continuously refined through machine learning techniques by incorporating new user interaction data, allowing it to dynamically update and evolve the pre-established user profile. This ongoing learning capability enables the system to detect increasingly sophisticated spoofing patterns over time by recognizing subtle deviations that may signal fraudulent attempts. To ensure user engagement and transparency, the system also includes a feedback module that delivers real-time responses to the user based on the authentication outcome. For example, if the authentication decision requires further review, the feedback module prompts the user to complete additional authentication steps, such as answering security questions or providing another biometric scan. This real-time feedback loop not only guides legitimate users through the authentication process but also acts as a deterrent against unauthorized attempts by signaling heightened security measures. Together, these components work in a coordinated manner to provide a robust, adaptive, and user-friendly authentication system that effectively mitigates identity spoofing risks while maintaining smooth user experience.

In an embodiment, the pattern recognition module further comprises a contextual anomaly detection sub-module configured to map feature deviations in the input data stream against multidimensional behavioral baselines derived from time-of-day, device orientation, and ambient noise profiles, wherein the sub-module segments incoming behavioral sequences into micro-events using a state-transition vector engine, wherein the deviation from expected event sequences is encoded into a compressed behavioral signature vector, and wherein this signature is input into the AI engine to refine anomaly classification by adjusting internal weights of the classification model through recursive backpropagation driven by anomaly distance gradients.

In this embodiment, the pattern recognition module is further enhanced by incorporating a contextual anomaly detection sub-module specifically designed to improve the precision of detecting irregularities in the input data stream. This sub-module operates by mapping deviations in observed features against a set of multidimensional behavioral baselines, which are derived from contextual parameters such as time-of-day variations, device orientation changes, and ambient noise profiles. By leveraging these contextual baselines, the system gains a more nuanced understanding of what constitutes normal behavior for a user in varying conditions.

The sub-module processes the incoming behavioral data by segmenting the continuous input into discrete micro-events through the use of a state-transition vector engine. This engine identifies transitions between different behavioral states or actions, effectively parsing the data stream into manageable segments representing fundamental units of user behavior. Each micro-event sequence is then analyzed to detect deviations from expected event patterns, and these deviations are encoded into a compressed behavioral signature vector. This signature vector acts as a concise representation of the behavioral anomaly, capturing the degree and nature of divergence from established norms.

The generated behavioral signature vector is subsequently fed into the AI engine, which utilizes this input to enhance the accuracy of anomaly classification. The AI engine dynamically refines its internal classification model by adjusting the model's weights through recursive backpropagation. This process is guided by anomaly distance gradients, which quantify how far the observed behavior deviates from the expected baseline. Through this iterative learning approach, the system continuously improves its ability to distinguish between benign behavioral variations and genuine security threats, thereby increasing the robustness and reliability of the overall authentication system.

In an embodiment, the AI engine includes a hybrid learning architecture comprising a continuously evolving online learning layer coupled with a frozen offline-trained model, wherein the online layer captures adaptive micro-changes in user-specific biometric and interaction features using a feature-drift-aware update mechanism that applies learning rate modulation based on entropy thresholds of incoming data segments, wherein the offline-trained model provides stable long-term profile references to prevent overfitting on transient anomalies, and wherein the synchronization of both layers occurs during low-activity authentication intervals to prevent performance bottlenecks during real-time decision making.

In this embodiment, the AI engine employs a hybrid learning architecture that integrates two complementary components: a continuously evolving online learning layer and a frozen offline-trained model. The online learning layer is specifically designed to capture and adapt to subtle, real-time micro-changes in user-specific biometric and interaction features. This layer incorporates a feature-drift-aware update mechanism that dynamically modulates the learning rate based on entropy thresholds calculated from incoming data segments, thereby enabling the system to prioritize meaningful feature variations while minimizing noise influence. Concurrently, the offline-trained model serves as a stable reference, representing the long-term user profile that is resistant to overfitting caused by transient anomalies or outlier events.

To maintain optimal system performance and prevent latency during critical authentication operations, synchronization between the online adaptive layer and the offline model occurs exclusively during low-activity authentication intervals. This scheduling strategy ensures that real-time decision-making processes remain uninterrupted and efficient, while the hybrid architecture collectively balances adaptability with robustness, enhancing overall accuracy and resilience in user authentication and anomaly detection.

In an embodiment, the feature extraction component employs a multi-level abstraction pipeline that transforms raw interaction data into behaviorally enriched tokens by applying frequency analysis on keystroke timing, touch pressure variance mapping using pressure-resistive interpolation, and gaze movement prediction using a Kalman filter-based eye trajectory modeling engine, wherein the resulting behavior tokens are mapped into a user-specific interaction lattice structure that preserves temporal, spatial, and intensity dimensions of user activity, and wherein this structure is continuously reconciled against the historical behavioral graph stored in the user profile repository.

In this embodiment, the multi-level abstraction pipeline within the feature extraction component further integrates a dynamic weighting mechanism that assigns contextual importance scores to each behaviorally enriched token based on situational factors such as device mode (e.g., mobile, desktop), application context, and environmental conditions like ambient lighting or noise levels. The frequency analysis applied on keystroke timing utilizes wavelet transform techniques to capture both transient and sustained typing rhythms, enhancing sensitivity to subtle deviations indicative of anomalous behavior.

The touch pressure variance mapping incorporates adaptive pressure-resistive interpolation calibrated through continuous sensor feedback loops, enabling real-time correction of sensor drift and ensuring high-fidelity pressure profiling. Meanwhile, the Kalman filter-based eye trajectory modeling engine incorporates a multi-dimensional state vector encompassing velocity, acceleration, and saccadic motion parameters to accurately predict gaze shifts, thus capturing both voluntary and involuntary eye movements.

The user-specific interaction lattice structure functions as a high-dimensional tensor, encoding temporal sequences along one axis, spatial coordinates along another, and intensity metrics as scalar weights within the lattice nodes. This lattice is dynamically aligned with the historical behavioral graph stored in the user profile repository using graph embedding techniques, which allow for efficient similarity computations and anomaly detection through continuous reconciliation processes. This reconciliation enables the system to promptly identify deviations from established behavioral patterns while adapting to natural user evolution over time.

In an embodiment, the decision engine applies a dual-confidence scoring algorithm that separately evaluates biometric and behavioral confidence scores derived from the pattern recognition module, wherein a biometric sub-score is generated by assessing matching probability distributions of current biometric vectors against historical templates using cosine similarity with adaptive thresholding, wherein the behavioral sub-score is computed by estimating deviation density in the multi-feature behavior space using a density-based outlier detection mechanism, and wherein the final authentication decision is made by fusing these scores through a trust-calibrated sigmoid blending function that adapts based on recent false positive feedback provided via the feedback module, wherein the action module is further configured to trigger a staged challenge-response protocol upon authentication flagging, wherein the protocol dynamically selects additional identity verification steps from a pre-ranked set of tasks including spontaneous gesture verification, short-term memory recall using personalized prompts, or device usage recall questions, wherein the ranking is computed based on historical success rates, context confidence, and environmental conditions such as ambient brightness and background noise levels as detected by the data acquisition module, and wherein the results of these tasks are independently scored and provided to the decision engine to augment the authentication confidence before executing final access control.

In this embodiment, the decision engine implements a dual-confidence scoring framework that independently quantifies biometric and behavioral authentication reliability. The biometric sub-score is generated by comparing the current biometric feature vector to stored historical templates using cosine similarity metrics with an adaptive threshold mechanism that dynamically adjusts based on recent user variability and environmental noise factors. Concurrently, the behavioral sub-score is derived from a density-based outlier detection algorithm that measures deviation density within a multi-dimensional behavior feature space, capturing anomalies in usage patterns such as typing cadence, application access frequency, and geolocation shifts.

These sub-scores are fused using a trust-calibrated sigmoid blending function, which incorporates feedback from the system's feedback module to recalibrate its parameters based on recent false positive or false negative incidents, thereby enhancing the adaptive accuracy of the authentication process. Upon a flagged authentication event, the action module initiates a staged challenge-response protocol, selecting verification tasks dynamically from a prioritized set including spontaneous gesture verification, personalized short-term memory recall prompts, and device usage recall queries. The task ranking is computed by analyzing historical task success rates, contextual confidence scores, and ambient environmental factors—such as brightness levels and background noise intensity detected by the data acquisition module—to optimize challenge relevance and effectiveness.

In an embodiment, the data acquisition module incorporates an intelligent context filtering layer that applies signal quality assessment and contextual plausibility scoring prior to processing, wherein biometric signals such as voice and facial input are evaluated using real-time SNR estimation and facial spoof detection via micro-texture analysis, and wherein user interaction patterns are filtered through an event entropy thresholding process that discards statistically improbable behavior sequences based on historically consistent user activity fingerprints, thereby reducing false detections and improving pattern recognition accuracy.

In this embodiment, the data acquisition module incorporates an intelligent context filtering layer that performs multi-tier signal quality assessment and contextual plausibility scoring prior to further processing. Specifically, biometric signals such as voice input undergo real-time Signal-to-Noise Ratio (SNR) estimation using adaptive spectral subtraction techniques to ensure only high-fidelity audio samples proceed to downstream analysis. Facial inputs are concurrently subjected to advanced facial spoof detection algorithms leveraging micro-texture analysis through Local Binary Patterns (LBP) and frequency domain feature extraction, enabling differentiation between live facial features and presentation attacks such as printed photos or video replays.

Additionally, user interaction patterns captured by the system are processed through an event entropy thresholding mechanism, wherein sequential behavior events are evaluated against a dynamically generated baseline fingerprint of historically consistent user activity. This entropy-based filtering discards behavior sequences that fall below a statistically determined plausibility threshold, effectively eliminating outlier or improbable event chains that could lead to false positive anomaly flags. By integrating this intelligent filtering layer, the system significantly enhances pattern recognition accuracy while reducing computational overhead and false detection rates within the authentication pipeline.

In an embodiment, the AI engine further includes a behavior state normalization component configured to align cross-session user interaction data using temporal warping and contextual synchronization, wherein this component segments incoming input streams based on active session markers and applies alignment transformations to compensate for variations in session initiation lag, device switching artifacts, and environmental shifts, and wherein the normalized behavior vector is appended with session entropy metadata before it is classified to improve resilience against session-specific spoofing.

In this embodiment, the AI engine comprises a behavior state normalization component that processes raw user interaction data by first identifying active session boundaries through session markers embedded in the input streams. This component employs temporal warping techniques—such as Dynamic Time Warping (DTW)—to temporally align behavioral sequences across different sessions, compensating for variable session start delays, device handoffs, and transient environmental changes. Contextual synchronization is further applied by integrating auxiliary sensor data (e.g., ambient light, device orientation, network conditions) to adjust and calibrate behavior features dynamically, ensuring consistency despite fluctuating external factors.

Following alignment, the normalized behavior vector is enriched with session entropy metadata, which quantifies the unpredictability and information content of user actions within that session, thereby encoding session-specific behavioral complexity. This appended vector is then input to downstream classifiers within the AI engine, enabling enhanced differentiation between genuine user activity and sophisticated session-targeted spoofing attempts, thus improving the robustness and reliability of the authentication process.

In an embodiment, the data acquisition module further integrates a sensor fusion interface for biometric and contextual signal alignment, wherein this interface timestamps and synchronizes input from multiple biometric sources including facial recognition frames, acoustic voiceprints, and gait vectors, wherein the synchronization is governed by a probabilistic fusion algorithm that weights each modality based on signal integrity and historical reliability scores, and wherein the resulting fused input vector is structured into a multi-modal authentication packet that is passed to the pattern recognition module for anomaly assessment.

In this embodiment, the sensor fusion interface within the data acquisition module employs a Bayesian inference framework to dynamically adjust the weighting factors assigned to each biometric modality in real-time, based on continuous evaluation of signal quality metrics such as frame clarity for facial images, signal-to-noise ratio for acoustic voiceprints, and stability indices for gait vectors. The interface utilizes timestamp correlation algorithms to achieve sub-millisecond synchronization accuracy across heterogeneous sensor inputs, thereby creating a temporally coherent multi-dimensional data representation. The fused input vector encapsulates modality-specific confidence scores alongside raw and processed biometric features, enabling the pattern recognition module to perform a comprehensive anomaly assessment that accounts for both individual sensor reliability and cross-modal corroboration, ultimately enhancing the precision and resilience of the authentication process against spoofing and sensor failure.

In an embodiment, the feature extraction component employs a hierarchical encoding pipeline that transforms low-level behavioral attributes such as cursor acceleration, scroll inertia, and tap dwell time into higher-order latent interaction features using a stack of one-dimensional convolutional encoders with dropout regularization, wherein the extracted latent features are cross-validated against dimensional anchors defined in the user's long-term behavioral signature using cosine proximity thresholds, and wherein deviations are forwarded as ranked anomaly indicators to the comparison component for decision contextualization.

In this embodiment, the hierarchical encoding pipeline of the feature extraction component comprises multiple layers of one-dimensional convolutional neural networks (1D-CNNs), each configured to capture progressively complex temporal dependencies in the input behavioral attributes, including cursor acceleration, scroll inertia, and tap dwell time. Dropout regularization is strategically applied after each convolutional layer to prevent overfitting and improve generalization across varying user interaction patterns. The resultant latent interaction features are projected into a multidimensional latent space where dimensional anchors, established from the user's historical behavioral signature, serve as reference vectors. Cosine proximity metrics are computed between the extracted features and these anchors to quantify conformity with the baseline behavioral profile. Deviations exceeding predefined thresholds are quantified and ranked to form anomaly indicators, which are then relayed to the comparison component. This comparison component contextualizes these anomaly indicators within the broader authentication decision framework to enable adaptive, risk-aware identity verification.

In an embodiment, the decision engine utilizes a context-aware decision graph that dynamically adjusts the decision thresholds based on user location, access time, and device type, wherein this graph structure includes confidence nodes weighted using recent authentication trend data and population-based behavior drift statistics, wherein anomalous paths through the graph trigger a recalibration step that delays access until a second-stage AI verification is performed, and wherein this process ensures the system adapts to evolving behavioral baselines while preserving stringent security constraints.

In this embodiment, the decision engine implements a context-aware decision graph structured as a directed acyclic graph (DAG), where each node represents a discrete authentication factor weighted by dynamically updated confidence scores derived from recent authentication outcomes and aggregated population-level behavior drift models. The graph edges encode conditional dependencies influenced by contextual parameters including geolocation coordinates, temporal access windows, and device classification metadata (e.g., mobile, desktop, IoT). During operation, anomalous traversals—identified via deviation scoring algorithms that compare live authentication vectors against adaptive baseline distributions—initiate a recalibration subroutine. This subroutine temporarily escalates the authentication state by invoking a secondary AI-powered verification module employing advanced ensemble learning techniques for high-assurance identity confirmation. The decision thresholds are thus continuously refined via feedback loops integrating real-time telemetry and historical trend analytics, enabling the system to maintain robust security postures while accommodating legitimate behavioral evolution and minimizing false positives.

In an embodiment, the comparison component includes a cross-instance anomaly resolver that identifies transient anomalies caused by short-term deviations such as temporary injury or device malfunction, wherein the resolver maintains a transient buffer that stores and contrasts recent interaction artifacts over a moving horizon window, wherein deviation persistence is quantified using a persistence likelihood index, and wherein only persistent deviation patterns are flagged for decision impact to prevent false rejection during temporary behavioral inconsistencies.

In this embodiment, the comparison component incorporates a cross-instance anomaly resolver configured to distinguish transient anomalies arising from short-term deviations such as temporary injury, device malfunction, or environmental disturbances. The resolver maintains a transient buffer that continuously stores and compares recent interaction artifacts within a moving horizon window, enabling temporal correlation analysis of behavioral data. A persistence likelihood index is computed to quantify the duration and consistency of deviations across successive instances. Only deviations exhibiting a persistence likelihood index exceeding a predetermined threshold are escalated and flagged for influencing the authentication decision, thereby minimizing false rejections caused by ephemeral behavioral inconsistencies while maintaining robust security against sustained anomalous activity.

In an embodiment, the feedback module further includes a passive confirmation engine that utilizes real-time micro-expressions and biometric postures captured during the feedback prompt interaction to re-validate the user identity without requiring active participation, wherein the captured features are processed using a fast-track neural submodule optimized for expression recognition under suboptimal lighting conditions, and wherein the passive confirmation score is fused into the authentication decision retroactively to enable silent approval or rejection based on real-time behavioral confidence.

In this embodiment, the feedback module further comprises a passive confirmation engine configured to unobtrusively capture and analyze real-time micro-expressions and biometric postures exhibited by the user during the feedback prompt interaction. The captured biometric features are processed by a specialized fast-track neural submodule designed for robust expression recognition, optimized to operate effectively under suboptimal lighting and varying environmental conditions. The passive confirmation engine computes a confidence score reflecting the degree of correlation between observed behavioral cues and the established user biometric profile. This passive confirmation score is subsequently fused retroactively into the overall authentication decision framework, enabling silent, non-intrusive approval or rejection of the authentication attempt based on continuous real-time behavioral confidence metrics, thereby enhancing security without imposing additional user burden.

In an embodiment, the AI engine supports real-time federated anomaly learning by communicating abstracted anomaly feature vectors with peer instances across distributed nodes, wherein these vectors are obfuscated using privacy-preserving transformation functions such as differential encoding with randomized masks, wherein the engine aggregates anomaly trends across nodes to detect coordinated spoofing attempts or pattern replication across systems, and wherein the anomaly trends are selectively integrated into the user profile to strengthen resistance against distributed identity spoofing attacks, and wherein the pattern recognition module includes a spoof pattern blacklist updater that periodically downloads verified spoof signature embeddings from a trusted central threat intelligence source, wherein these signatures are matched using vector cosine proximity in the behavior space against incoming interaction patterns, wherein partial matches result in incremental spoof probability adjustments rather than immediate rejection, and wherein the update frequency of the blacklist is adaptively controlled based on spoof attempt density observed in recent authentications.

In this embodiment, the AI engine facilitates real-time federated anomaly learning by exchanging abstracted anomaly feature vectors with peer instances distributed across multiple nodes. These feature vectors undergo privacy-preserving transformations, such as differential encoding combined with randomized masking techniques, to ensure data confidentiality while enabling collaborative learning. The AI engine aggregates anomaly trends identified across the distributed network to detect coordinated spoofing attempts and replicated behavioral patterns targeting multiple systems. These aggregated trends are selectively incorporated into individual user profiles to enhance the system's resilience against distributed identity spoofing attacks. Furthermore, the pattern recognition module integrates a spoof pattern blacklist updater configured to periodically retrieve verified spoof signature embeddings from a trusted central threat intelligence source. The module employs vector cosine similarity metrics within the behavior feature space to match incoming interaction patterns against the blacklist. Partial matches incrementally adjust the spoof probability score instead of triggering immediate rejection, thereby allowing nuanced decision-making. The frequency of blacklist updates is adaptively modulated based on the density of spoofing attempts observed in recent authentication events, optimizing both system responsiveness and network resource utilization.

In an embodiment, the security protocol triggered by the action module includes a forensic trace capture subroutine that creates a timestamped and encrypted log of all raw biometric and interaction signals leading to the authentication flag, wherein this log is structured using an append-only block-chained format to preserve integrity, wherein each block includes a cryptographic hash of its content and temporal context markers, and wherein the log is automatically uploaded to a secure forensic analysis queue for administrative review or legal compliance auditing.

In this embodiment, the forensic trace capture subroutine further integrates a real-time anomaly tagging mechanism that annotates the logged biometric and interaction signals with contextual metadata, including sensor source identifiers, signal quality metrics, and environmental condition parameters at the time of capture. The append-only block-chained log structure employs a Merkle tree architecture to enable efficient verification of data integrity and selective retrieval of specific event subsets without compromising the immutability of the overall log. Additionally, the subroutine incorporates automated cryptographic key rotation and multi-factor encryption schemes to safeguard the log data during transmission and storage. The secure forensic analysis queue is configured with prioritized processing rules that trigger immediate alerts to designated security personnel upon detection of high-severity anomalies, thereby expediting incident response workflows while maintaining comprehensive audit trails for compliance purposes.

In an embodiment, the decision engine incorporates a rolling reputation score for each user that tracks the historical outcome of authentication events including false rejections, false acceptances, and challenge success rates, wherein this score is calculated using an exponentially decaying memory function to prioritize recent events, wherein users with consistently high scores are temporarily fast-tracked through low-risk authentications via pre-approval tokens embedded in the user device, and wherein these tokens are revoked in real time if any high-risk anomaly is subsequently detected.

In this embodiment, the decision engine further includes a dynamic trust calibration module that continuously updates the rolling reputation score by integrating contextual risk factors such as device health status, network security posture, and recent geolocation anomalies. The exponentially decaying memory function applies a weighted decay parameter tuned via reinforcement learning algorithms to optimize sensitivity to emerging behavioral shifts. Pre-approval tokens are cryptographically secured and time-bound, employing hardware-backed secure elements within the user device to prevent tampering. Real-time revocation of these tokens is enforced through a low-latency push notification mechanism coordinated with the session management system, ensuring immediate suspension of fast-track privileges upon detection of any high-risk anomaly, thereby maintaining a balance between user convenience and system security.

In an embodiment, the decision engine includes a dynamic threshold recalibration module that modifies its classification confidence boundaries based on a rolling average of system-wide false rejection rates, wherein the recalibration is activated when the deviation ratio between expected and observed authentication failure rates exceeds a pre-defined variance threshold, and wherein the module adjusts the AI engine's anomaly scoring function by introducing contextual confidence penalties tied to feature volatility indices derived from recent interaction sequences, wherein the pattern recognition module further comprises a temporal sequence validator that encodes behavior sequences as Markov transition graphs with embedded temporal edge weights, wherein these graphs are compared against historical graph templates stored in the pre-established user profile using graph edit distance measures, and wherein sequences exhibiting abnormal transitions or altered timing characteristics are marked with a cumulative spoof likelihood score for downstream decision analysis.

In this embodiment, the decision engine further comprises a dynamic threshold recalibration module that autonomously adjusts its classification confidence boundaries by continuously monitoring a rolling average of system-wide false rejection rates. This recalibration process is triggered when the deviation ratio between the expected and observed authentication failure rates surpasses a predefined variance threshold, ensuring adaptive response to evolving user behavior patterns and system conditions. The module refines the AI engine's anomaly scoring function by incorporating contextual confidence penalties associated with feature volatility indices, which are calculated from recent user interaction sequences to account for temporal instability in behavioral features. Additionally, the pattern recognition module includes a temporal sequence validator that models user behavior sequences as Markov transition graphs enriched with temporal edge weights, effectively capturing both the order and timing of interactions. These temporal graphs are systematically compared against stored historical graph templates within the pre-established user profile using graph edit distance metrics. Sequences that exhibit abnormal state transitions or deviations in temporal dynamics are assigned a cumulative spoof likelihood score, which is utilized in downstream decision-making processes to enhance the accuracy and robustness of authentication outcomes.

In an embodiment, the biometric sensors in the data acquisition module implement real-time quality scoring of input signals based on sharpness, signal-to-noise ratio, background interference metrics, and anatomical landmark stability, wherein each modality is independently weighted using a confidence vector that influences its relative influence during multi-modal fusion, and wherein signal sources falling below an adaptive minimum quality threshold are excluded from decision consideration to reduce susceptibility to low-quality spoof vectors, wherein the additional identity verification step within the security protocol includes a cognitive challenge-response task dynamically selected from a library of user-personalized micro-interaction puzzles, wherein task selection is based on behavioral familiarity and minimal cognitive load, and wherein user responses are analyzed not only for correctness but also for behavioral execution traits such as latency, rhythm, hesitation markers, and pattern stability across retries, and wherein deviations from established micro-interaction signatures influence the overall authentication verdict.

In this embodiment, the data acquisition module's biometric sensors perform real-time quality assessment by computing metrics such as image sharpness, signal-to-noise ratio, background interference levels, and the stability of anatomical landmarks specific to each modality. Each biometric modality is assigned a confidence weight within a multi-dimensional confidence vector, which dynamically adjusts its contribution during the multi-modal data fusion process. Inputs with quality metrics falling below an adaptive threshold—determined by historical signal performance and environmental context—are systematically excluded from further authentication analysis to mitigate the risk of incorporating low-quality or spoofed biometric data. The security protocol's additional identity verification step includes a cognitive challenge-response mechanism, wherein a personalized micro-interaction puzzle is dynamically selected from a user-specific task library.

Selection criteria prioritize behavioral familiarity to the user and aim to minimize cognitive load, thereby enhancing user experience and compliance. User responses to these cognitive challenges are evaluated not only on correctness but also on behavioral execution parameters, including response latency, interaction rhythm, hesitation markers, and consistency of response patterns across multiple attempts. Deviations from the user's established micro-interaction behavioral signature are quantitatively integrated into the authentication decision framework, thereby refining the overall verdict with enhanced sensitivity to spoofing or anomalous behavior.

In an embodiment, the feature extraction component is coupled with an adaptive input segmentation engine that dissects continuous behavioral input streams into discrete temporal epochs based on event density, inter-action gap thresholds, and engagement intent estimation, wherein each epoch is independently analyzed to isolate outlier sub-patterns, and wherein anomalous epochs trigger epoch-level feature dropout to prevent isolated noisy behavior from distorting the authentication decision, and wherein the AI engine includes an attention-based anomaly explainer module configured to generate human-readable explanations for flagged spoof attempts, wherein the module identifies feature subsets with highest contribution to anomaly scoring using layer-wise relevance propagation and gradient-based saliency mapping, and wherein the explanation output is integrated into the feedback module to guide users through potential causes and resolutions of authentication failure in a privacy-preserving manner.

In this embodiment, the adaptive input segmentation engine employs a multi-criteria algorithm combining event density analysis, inter-action temporal gap thresholds, and a predictive engagement intent model to partition continuous behavioral data streams into discrete temporal epochs. Each epoch undergoes localized statistical profiling and unsupervised clustering to identify outlier sub-patterns within the segmented window. When anomalous epochs are detected, the system triggers an epoch-level feature dropout mechanism that selectively excludes features derived from the noisy segment, thereby preserving the integrity of the overall authentication decision by mitigating distortion from transient behavioral anomalies. The AI engine's attention-based anomaly explainer module utilizes advanced interpretability techniques, including layer-wise relevance propagation and gradient-based saliency mapping, to isolate and quantify the contribution of individual feature subsets to the anomaly score assigned during authentication. These interpretable insights are formatted into concise, human-readable explanations which are securely relayed through the feedback module, providing end-users with actionable guidance on potential causes of authentication failure while maintaining strict privacy constraints by abstracting sensitive data. This feedback facilitates informed user responses, such as retrying authentication under improved conditions or initiating support protocols, thereby enhancing system transparency and user trust.

In an embodiment, the session termination protocol triggered by the action module is augmented with an intrusion traceback module that captures volatile system memory snapshots, ongoing sensor feed caches, device process trees, and user application contexts prior to full session kill, wherein the captured data is stored in a quarantined enclave with restricted access, and wherein forensic analysis routines can be run post-event to determine the entry vector and spoof strategy used, wherein the feedback module includes a biometric liveness prompt feature that, upon an inconclusive authentication decision, initiates an interactive biometric verification involving user-guided real-time gestures such as head tilts, blinking patterns, or voice inflections, wherein the captured data is validated using a liveness detection model trained on adversarially augmented datasets including synthetic forgeries and adversary-imitation samples, and wherein the prompt adapts in complexity based on prior spoof detection severity.

In this embodiment, the session termination protocol, when triggered by the action module, is enhanced with an intrusion traceback module configured to capture volatile system memory snapshots, ongoing sensor feed caches, device process hierarchies, and active user application contexts immediately prior to executing a full session kill. The collected data is securely stored within a quarantined enclave featuring strict access controls to prevent tampering or unauthorized retrieval. Post-event, dedicated forensic analysis routines can be executed within this enclave to reconstruct the attack timeline, identify the entry vector exploited, and elucidate the spoofing strategy employed by the adversary. Concurrently, the feedback module is augmented with a biometric liveness prompt feature which, upon an inconclusive authentication decision, initiates an interactive biometric verification sequence requiring user-performed real-time gestures such as controlled head tilts, blinking patterns, or voice inflections. The biometric data captured during this sequence is processed and validated using a liveness detection model trained on adversarially augmented datasets incorporating synthetic forgery examples and adversary-imitation samples, thereby improving robustness against sophisticated spoofing attempts. Moreover, the complexity and nature of the liveness prompt dynamically adapt based on historical spoof detection severity, providing graduated challenge levels to enhance authentication confidence while minimizing user friction.

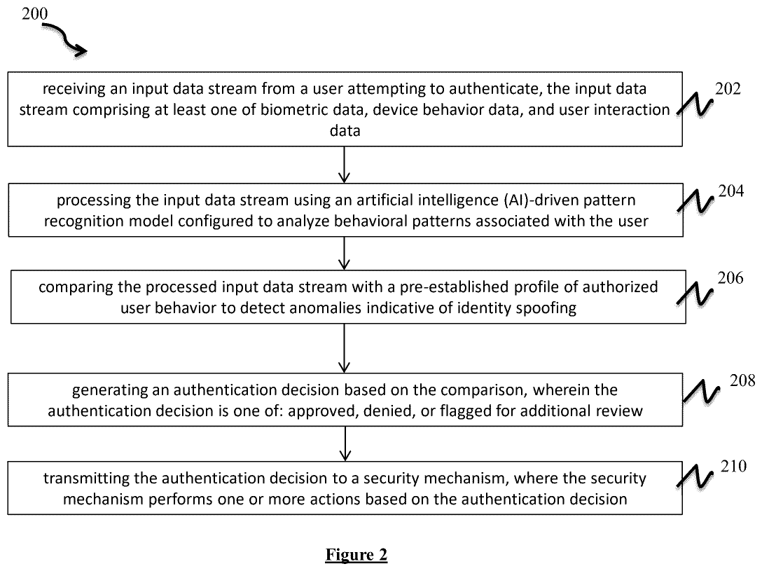

Referring to FIG. 2, a flow chart of a method for Preventing Identity Spoofing Using AI-Driven Pattern Recognition is illustrated. The method 100 comprising:

At step 202, the method 200 includes receiving an input data stream from a user attempting to authenticate, the input data stream comprising at least one of biometric data, device behavior data, and user interaction data;

At step 204, the method 200 includes processing the input data stream using an artificial intelligence (AI)-driven pattern recognition model configured to analyze behavioral patterns associated with the user;

At step 206, the method 200 includes comparing the processed input data stream with a pre-established profile of authorized user behavior to detect anomalies indicative of identity spoofing;

At step 208, the method 200 includes generating an authentication decision based on the comparison, wherein the authentication decision is one of: approved, denied, or flagged for additional review;

At step 210, the method 200 includes transmitting the authentication decision to a security mechanism, where the security mechanism performs one or more actions based on the authentication decision.

In an embodiment, the input data stream further comprises at least one of facial recognition data, voice recognition data, typing rhythm data, and touchscreen interaction data.

In an embodiment, the AI-driven pattern recognition model is a deep learning model trained on a dataset comprising historical biometric data, device usage patterns, and user behavior analytics.

In an embodiment, the comparison step further comprises calculating a similarity score between the processed input data stream and the pre-established profile, the similarity score indicating the likelihood that the input data stream is authentic.

In an embodiment, the authentication decision is based on the similarity score exceeding a predefined threshold value, where the threshold value is dynamically adjusted based on real-time system learning and updates to the AI model.

In an embodiment, the AI-driven pattern recognition model incorporates anomaly detection techniques that identify patterns of behavior deviating significantly from previously established norms within the profile.

In an embodiment, the device behavior data includes at least one of device location, device typing speed, and frequency of user application usage, and wherein the comparison step further includes detecting inconsistencies in these device behaviors.

In an embodiment, comprising the step of triggering a secondary authentication mechanism when the authentication decision is flagged for additional review, wherein the secondary authentication mechanism comprises at least one of a multi-factor authentication (MFA) system, a one-time password (OTP) verification, or a security question prompt.

The present invention relates to a method and system for preventing identity spoofing in a digital authentication process through the use of AI-driven pattern recognition. The system operates by receiving an input data stream from a user attempting to authenticate. This data stream can include various types of information such as biometric data (e.g., facial recognition data, voice recognition data, fingerprints), device behavior data (e.g., device usage patterns, typing speed, geographical location), and user interaction data (e.g., touch patterns, swipe behavior, etc.). The core of the system involves processing the received input data stream using an artificial intelligence (AI)-driven pattern recognition model, which is specifically designed to analyze behavioral patterns associated with the legitimate user.

The AI model employed in this system utilizes advanced machine learning techniques, including deep learning and classification techniques like support vector machines (SVM), random forests, and neural networks, to identify and process unique patterns within the user's input data. The model is trained on a vast dataset comprising historical biometric data, device usage patterns, and user behavior analytics, which allows it to establish a robust user profile that reflects the normal behavior of the user. As a result, the system can detect deviations from the established patterns that may indicate potential identity spoofing.

Once the input data stream is processed, the system compares the resulting data against the pre-established profile to detect any anomalies. The comparison step involves calculating a similarity score between the processed input data stream and the authorized user profile. This score quantifies the degree of similarity between the current input and past authenticated behavior, thus providing a measure of confidence regarding the authenticity of the user. If the similarity score exceeds a predefined threshold, the system generates an authentication decision. However, if the score is below the threshold or if significant anomalies are detected in the data, the system flags the authentication request for further review.

The decision engine is responsible for generating the authentication decision, which can be one of three outcomes: approval, denial, or flagging for additional review. If the authentication is flagged, the system can trigger a secondary authentication mechanism, such as multi-factor authentication (MFA), a one-time password (OTP) verification, or a security question prompt, to further verify the user's identity before granting access. This additional verification ensures that the system can effectively mitigate potential spoofing attempts while balancing user convenience.

To enhance the accuracy and efficiency of identity spoofing detection, the AI engine incorporates anomaly detection techniques. These techniques identify patterns that deviate significantly from the normal behavior established in the user's profile. For example, changes in typing speed, device usage frequency, or unusual geographical location might be flagged as potential indicators of spoofing. Additionally, the system continuously learns from new user interaction data, dynamically updating the user profile to account for any gradual changes in behavior over time. This adaptive learning mechanism allows the system to improve the accuracy of the authentication process and detect evolving spoofing techniques.

The data acquisition module of the system includes biometric sensors that capture various forms of biometric data, such as facial images, fingerprints, voice recordings, or eye patterns. These sensors play a critical role in collecting reliable user data, which is then fed into the pattern recognition module. The device behavior data, which can include information about how the user interacts with their device, such as typing behavior, application access patterns, and location data, is also analyzed to detect inconsistencies that could suggest an identity spoofing attempt.

The system's feedback module plays a key role in providing real-time feedback to users. When an authentication request is flagged for review, the feedback module can prompt the user to undergo additional verification steps. This ensures that the user is kept informed and that any potential security risks are mitigated promptly. Additionally, the action module is responsible for triggering appropriate security protocols based on the authentication decision. If the decision is to deny access or flag the request for further review, the system can alert a security administrator, initiate an additional identity verification step, or even terminate the session to prevent unauthorized access.

The system is designed to provide a robust solution for identity spoofing prevention by combining multiple layers of behavioral analysis, real-time anomaly detection, and adaptive learning. By continuously updating the user profile and leveraging AI-driven pattern recognition, the system ensures that only legitimate users are granted access while minimizing the risks of spoofing and unauthorized access. Furthermore, the system's ability to trigger secondary authentication measures and feedback mechanisms offers an added layer of security and user assurance.

A non-transitory computer-readable medium stores the instructions for implementing the method described above. When executed by a processor, these instructions cause the system to perform the steps of receiving input data, processing it using AI-driven pattern recognition, comparing the data with the pre-established user profile, generating an authentication decision, and performing appropriate actions based on that decision. Moreover, the instructions also enable the system to implement an adaptive learning mechanism that refines the authentication process over time based on new user behavior data and identified spoofing patterns, ensuring the continued effectiveness and accuracy of the system.

The invention consists of a physical AI-based identity verification device and a method for processing identity inputs to prevent spoofing attacks. The core structure of the device, AIPRIM, is housed in a compact, tamper-proof casing constructed from anodized aluminum reinforced with polymer layers for shock resistance. The front panel of the module incorporates an advanced biometric sensor array including a near-infrared (NIR) camera for 3D facial mapping, a MEMS microphone for vocal pattern capture, a capacitive fingerprint scanner, and a pressure-sensitive keyboard interface.

Internally, the device comprises a system-on-chip (SoC) module equipped with a secure enclave, a neural processing unit (NPU), an embedded real-time operating system (RTOS), and an encrypted non-volatile memory unit. The NPU executes a hybrid AI model composed of CNN, RNN, and GAN-based spoof detection modules trained on a large dataset of spoofing and genuine interaction patterns. The secure enclave ensures that all biometric and behavioral data processing occurs in a protected environment, inaccessible to external applications.

In operation, when a user attempts authentication, the AIPRIM device collects a fusion of data modalities including facial features with liveness detection, voice commands with emotional tone recognition, and keystroke dynamics captured over time. The preprocessing module filters, encodes, and normalizes the raw data into multidimensional tensors. These are subsequently fed into the hybrid AI model which calculates a multidimensional authenticity score. If the score exceeds a dynamic, context-dependent threshold (adjusted based on user risk profile and situational metadata), a digitally signed trust token is generated using an embedded cryptographic engine.

The trust token is then transmitted to a connected host system, such as a secure terminal, online banking interface, or smart door controller, using an encrypted protocol such as TLS 1.3 with mutual authentication. If the score falls below the threshold, a spoofing alert is issued, and the data is logged for forensics.

The invention supports adaptive learning through a federated learning mechanism wherein anonymized pattern deltas from multiple deployed AIPRIM units are aggregated into a central AI model trainer without transmitting raw biometric data. This ensures continual learning and model updates while maintaining strict user data privacy.

Furthermore, the AIPRIM device includes a machine status monitor that logs tamper events, performance metrics, and environmental anomalies using onboard sensors and transmits secure reports to a central security management console.

In an illustrative embodiment, the device is mounted onto secure access terminals such as ATMs, airport immigration kiosks, or enterprise login stations. When installed, it interfaces with existing IT infrastructure using standard APIs and can be powered via USB or PoE (Power over Ethernet) configurations.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for preventing identity spoofing in a digital authentication process, comprising:
a data acquisition module configured to receive an input data stream from a user, the input data stream including biometric data, device behavior data, or user interaction data;
a pattern recognition module comprising an artificial intelligence (AI) engine configured to process and analyze the input data stream by comparing it with a pre-established user profile, wherein the AI engine utilizes one or more pattern recognition techniques to detect anomalies that indicate identity spoofing;
a decision engine configured to generate an authentication decision based on the output of the pattern recognition module;
an action module in communication with the decision engine, wherein the action module performs one or more actions based on the authentication decision, the actions including granting or denying access or flagging the authentication for additional review, wherein the AI engine uses a machine learning-based classification technique selected from the group consisting of support vector machines (SVM), random forests, and neural networks to analyze the input data stream, wherein the pre-established user profile includes a repository of historical biometric data, user device usage statistics, and interaction patterns, which are continuously updated to enhance the accuracy of identity verification; and wherein the pattern recognition module further includes a feature extraction component that extracts behavioral features from the input data stream, and a comparison component that compares the extracted features with the established user profile, wherein the action module further triggers a security protocol when the authentication decision is flagged for additional review, wherein the security protocol includes at least one of alerting a security administrator, initiating an additional identity verification step, or initiating a session termination protocol, wherein the data acquisition module includes biometric sensors configured to capture at least one of facial images, fingerprints, voice recordings, or eye patterns for use in the authentication process, wherein the device behavior data includes at least one of device usage patterns, typing behavior, application access patterns, and geographical location, and wherein the pattern recognition module analyzes this data to detect potential identity spoofing attempts, wherein the AI engine continuously learns from new user interaction data and dynamically updates the pre-established user profile to improve the detection of spoofing patterns, and wherein the system further comprises a feedback module that provides real-time feedback to the user based on the outcome of the authentication decision, wherein the feedback includes a prompt for additional authentication if the decision is flagged for review, and wherein the pattern recognition module further comprises a contextual anomaly detection sub-module configured to map feature deviations in the input data stream against multidimensional behavioral baselines derived from time-of-day, device orientation, and ambient noise profiles, wherein the sub-module segments incoming behavioral sequences into micro-events using a state-transition vector engine, wherein the deviation from expected event sequences is encoded into a compressed behavioral signature vector, wherein this signature is input into the AI engine to refine anomaly classification by adjusting internal weights of the classification model through recursive backpropagation driven by anomaly distance gradients, and wherein the AI engine includes a hybrid learning architecture comprising a continuously evolving online learning layer coupled with a frozen offline-trained model, wherein the online layer captures adaptive micro-changes in user-specific biometric and interaction features using a feature-drift-aware update mechanism that applies learning rate modulation based on entropy thresholds of incoming data segments, wherein the offline-trained model provides stable long-term profile references to prevent overfitting on transient anomalies, and wherein the synchronization of both layers occurs during low-activity authentication intervals to prevent performance bottlenecks during real-time decision making, and wherein the feature extraction component employs a multi-level abstraction pipeline that transforms raw interaction data into behaviorally enriched tokens by applying frequency analysis on keystroke timing, touch pressure variance mapping using pressure-resistive interpolation, and gaze movement prediction using a Kalman filter-based eye trajectory modeling engine, wherein the resulting behavior tokens are mapped into a user-specific interaction lattice structure that preserves temporal, spatial, and intensity dimensions of user activity, and wherein this structure is continuously reconciled against the historical behavioral graph stored in the user profile repository.

2. The system of claim 1, wherein the decision engine applies a dual-confidence scoring algorithm that separately evaluates biometric and behavioral confidence scores derived from the pattern recognition module, wherein a biometric sub-score is generated by assessing matching probability distributions of current biometric vectors against historical templates using cosine similarity with adaptive thresholding, wherein the behavioral sub-score is computed by estimating deviation density in the multi-feature behavior space using a density-based outlier detection mechanism, and wherein the final authentication decision is made by fusing these scores through a trust-calibrated sigmoid blending function that adapts based on recent false positive feedback provided via the feedback module, wherein the action module is further configured to trigger a staged challenge-response protocol upon authentication flagging, wherein the protocol dynamically selects additional identity verification steps from a pre-ranked set of tasks including spontaneous gesture verification, short-term memory recall using personalized prompts, or device usage recall questions, wherein the ranking is computed based on historical success rates, context confidence, and environmental conditions such as ambient brightness and background noise levels as detected by the data acquisition module, and wherein the results of these tasks are independently scored and provided to the decision engine to augment the authentication confidence before executing final access control, and wherein the data acquisition module incorporates an intelligent context filtering layer that applies signal quality assessment and contextual plausibility scoring prior to processing, wherein biometric signals such as voice and facial input are evaluated using real-time SNR estimation and facial spoof detection via micro-texture analysis, and wherein user interaction patterns are filtered through an event entropy thresholding process that discards statistically improbable behavior sequences based on historically consistent user activity fingerprints, thereby reducing false detections and improving pattern recognition accuracy.

3. The system of claim 1, wherein the AI engine further includes a behavior state normalization component configured to align cross-session user interaction data using temporal warping and contextual synchronization, wherein this component segments incoming input streams based on active session markers and applies alignment transformations to compensate for variations in session initiation lag, device switching artifacts, and environmental shifts, and wherein the normalized behavior vector is appended with session entropy metadata before it is classified to improve resilience against session-specific spoofing.

4. The system of claim 1, wherein the data acquisition module further integrates a sensor fusion interface for biometric and contextual signal alignment, wherein this interface timestamps and synchronizes input from multiple biometric sources including facial recognition frames, acoustic voiceprints, and gait vectors, wherein the synchronization is governed by a probabilistic fusion algorithm that weights each modality based on signal integrity and historical reliability scores, and wherein the resulting fused input vector is structured into a multi-modal authentication packet that is passed to the pattern recognition module for anomaly assessment.

5. The system of claim 1, wherein the feature extraction component employs a hierarchical encoding pipeline that transforms low-level behavioral attributes such as cursor acceleration, scroll inertia, and tap dwell time into higher-order latent interaction features using a stack of one-dimensional convolutional encoders with dropout regularization, wherein the extracted latent features are cross-validated against dimensional anchors defined in the user's long-term behavioral signature using cosine proximity thresholds, and wherein deviations are forwarded as ranked anomaly indicators to the comparison component for decision contextualization.

6. The system of claim 1, wherein the decision engine utilizes a context-aware decision graph that dynamically adjusts the decision thresholds based on user location, access time, and device type, wherein this graph structure includes confidence nodes weighted using recent authentication trend data and population-based behavior drift statistics, wherein anomalous paths through the graph trigger a recalibration step that delays access until a second-stage AI verification is performed, and wherein this process ensures the system adapts to evolving behavioral baselines while preserving stringent security constraints.

7. The system of claim 1, wherein the comparison component includes a cross-instance anomaly resolver that identifies transient anomalies caused by short-term deviations such as temporary injury or device malfunction, wherein the resolver maintains a transient buffer that stores and contrasts recent interaction artifacts over a moving horizon window, wherein deviation persistence is quantified using a persistence likelihood index, and wherein only persistent deviation patterns are flagged for decision impact to prevent false rejection during temporary behavioral inconsistencies.

8. The system of claim 1, wherein the feedback module further includes a passive confirmation engine that utilizes real-time micro-expressions and biometric postures captured during the feedback prompt interaction to re-validate the user identity without requiring active participation, wherein the captured features are processed using a fast-track neural submodule optimized for expression recognition under suboptimal lighting conditions, and wherein the passive confirmation score is fused into the authentication decision retroactively to enable silent approval or rejection based on real-time behavioral confidence.

9. The system of claim 1, wherein the AI engine supports real-time federated anomaly learning by communicating abstracted anomaly feature vectors with peer instances across distributed nodes, wherein these vectors are obfuscated using privacy-preserving transformation functions such as differential encoding with randomized masks, wherein the engine aggregates anomaly trends across nodes to detect coordinated spoofing attempts or pattern replication across systems, and wherein the anomaly trends are selectively integrated into the user profile to strengthen resistance against distributed identity spoofing attacks, and wherein the pattern recognition module includes a spoof pattern blacklist updater that periodically downloads verified spoof signature embeddings from a trusted central threat intelligence source, wherein these signatures are matched using vector cosine proximity in the behavior space against incoming interaction patterns, wherein partial matches result in incremental spoof probability adjustments rather than immediate rejection, and wherein the update frequency of the blacklist is adaptively controlled based on spoof attempt density observed in recent authentications.

10. The system of claim 1, wherein the security protocol triggered by the action module includes a forensic trace capture subroutine that creates a timestamped and encrypted log of all raw biometric and interaction signals leading to the authentication flag, wherein this log is structured using an append-only block-chained format to preserve integrity, wherein each block includes a cryptographic hash of its content and temporal context markers, and wherein the log is automatically uploaded to a secure forensic analysis queue for administrative review or legal compliance auditing.

11. The system of claim 1, wherein the decision engine incorporates a rolling reputation score for each user that tracks the historical outcome of authentication events including false rejections, false acceptances, and challenge success rates, wherein this score is calculated using an exponentially decaying memory function to prioritize recent events, wherein users with consistently high scores are temporarily fast-tracked through low-risk authentications via pre-approval tokens embedded in the user device, and wherein these tokens are revoked in real time if any high-risk anomaly is subsequently detected.

12. The system of claim 1, wherein the decision engine includes a dynamic threshold recalibration module that modifies its classification confidence boundaries based on a rolling average of system-wide false rejection rates, wherein the recalibration is activated when the deviation ratio between expected and observed authentication failure rates exceeds a pre-defined variance threshold, and wherein the module adjusts the AI engine's anomaly scoring function by introducing contextual confidence penalties tied to feature volatility indices derived from recent interaction sequences, wherein the pattern recognition module further comprises a temporal sequence validator that encodes behavior sequences as Markov transition graphs with embedded temporal edge weights, wherein these graphs are compared against historical graph templates stored in the pre-established user profile using graph edit distance measures, and wherein sequences exhibiting abnormal transitions or altered timing characteristics are marked with a cumulative spoof likelihood score for downstream decision analysis.

13. The system of claim 1, wherein the biometric sensors in the data acquisition module implement real-time quality scoring of input signals based on sharpness, signal-to-noise ratio, background interference metrics, and anatomical landmark stability, wherein each modality is independently weighted using a confidence vector that influences its relative influence during multi-modal fusion, and wherein signal sources falling below an adaptive minimum quality threshold are excluded from decision consideration to reduce susceptibility to low-quality spoof vectors, wherein the additional identity verification step within the security protocol includes a cognitive challenge-response task dynamically selected from a library of user-personalized micro-interaction puzzles, wherein task selection is based on behavioral familiarity and minimal cognitive load, and wherein user responses are analyzed not only for correctness but also for behavioral execution traits such as latency, rhythm, hesitation markers, and pattern stability across retries, and wherein deviations from established micro-interaction signatures influence the overall authentication verdict.

14. The system of claim 1, wherein the feature extraction component is coupled with an adaptive input segmentation engine that dissects continuous behavioral input streams into discrete temporal epochs based on event density, inter-action gap thresholds, and engagement intent estimation, wherein each epoch is independently analyzed to isolate outlier sub-patterns, and wherein anomalous epochs trigger epoch-level feature dropout to prevent isolated noisy behavior from distorting the authentication decision, and wherein the AI engine includes an attention-based anomaly explainer module configured to generate human-readable explanations for flagged spoof attempts, wherein the module identifies feature subsets with highest contribution to anomaly scoring using layer-wise relevance propagation and gradient-based saliency mapping, and wherein the explanation output is integrated into the feedback module to guide users through potential causes and resolutions of authentication failure in a privacy-preserving manner.

15. The system of claim 1, wherein the session termination protocol triggered by the action module is augmented with an intrusion traceback module that captures volatile system memory snapshots, ongoing sensor feed caches, device process trees, and user application contexts prior to full session kill, wherein the captured data is stored in a quarantined enclave with restricted access, and wherein forensic analysis routines can be run post-event to determine the entry vector and spoof strategy used, wherein the feedback module includes a biometric liveness prompt feature that, upon an inconclusive authentication decision, initiates an interactive biometric verification involving user-guided real-time gestures such as head tilts, blinking patterns, or voice inflections, wherein the captured data is validated using a liveness detection model trained on adversarially augmented datasets including synthetic forgeries and adversary-imitation samples, and wherein the prompt adapts in complexity based on prior spoof detection severity.
